(19) United States
(12) Patent Application Publication
(10) Pub. No.: US 2003/0099886 A1
(43) Pub. Date: May 29, 2003

(54) Nonaqueous electrolyte composition for improving overcharge safety and lithium battery using the same

(75) Inventors: Sang-hoon Choy, Daejeon-city (KR); Ho-sung Kim, Yongin-city (KR); Hee-young Sun, Yongin-city (KR); Hyeong-gon Noh, Seoul (KR)

Correspondence Address: McGuireWoods,, Suite 1800, 1750 Tysons Boulevard, McLean, VA, 22102-4215, US

(73) Assignee: Samsung SDI Co., Ltd.

(21) Appl. No.: 10/270,669

(22) Filed: Oct. 16, 2002

(30) Foreign Application Priority Data
Oct. 20, 2001 (KR) 01-64939

(51) Int. Cl. H01M 10/40

(52) U.S. Cl. 429/328; 429/200; 429/329

(57) ABSTRACT

Provided are a nonaqueous electrolyte for improving battery safety by suppressing risks associated with the battery becoming overcharged as a result of certain uncontrolled conditions and a lithium battery with improved overcharge safety. The nonaqueous electrolyte includes an organic solvent, a lithium salt, and a biphenylene oxide based compound.

### BACKGROUND OF THE INVENTION

1. Field of the Invention

The present invention relates to a nonaqueous electrolyte for improving overcharge safety and a lithium battery using the same.

2. Description of the Related Art

According to the development of advanced electronic devices, there is an increasing demand for small, lightweight portable electronic devices and equipment. Thus, there is a need for batteries having high energy density characteristics so as to supply a power to such devices and equipment, and research into such lithium batteries is currently being vigorously carried out.

A lithium battery comprises a cathode, an anode, an electrolyte for providing a movement path of lithium ions and a separator disposed between the cathode and the anode. Lithium batteries produce an electrical energy by intercalation/deintercalation of lithium ions during oxidation and reduction occurring at the cathode and the anode. However, in the case where a battery is overcharged due to malfuction of a charger, for example, causing a sharp rise in voltage, excess lithium is precipitated at the cathode and excess lithium is intercalated into the anode. If both the cathode and the anode are thermally unstable, an organic solvent of the electrolyte is decomposed to cause rapid heat generation, such as thermal runaway, adversely affecting safety of the battery.

To overcome the foregoing disadvantage, various attempts to suppress overcharge of a battery by changing the composition of an electrolyte or adding additives to the electrolyte have been proposed in the field of lithium ion batteries. For example, U.S. Pat. No. 5,580,684 discloses a method of improving safety of a battery by increasing a self-extinguishing property of an electrolyte by adding phosphoric acid esters, such as trimethyl phosphate, tri(trifluoroethyl)phosphate or tri(2-chloroethyl)phosphate, to the electrolyte.

In addition, U.S. Pat. No. 5,776,627 discloses a method of enhancing battery safety by preventing migration of lithium by adding some additives such as thiophene, biphenyl or furan to be polymerized in the event of failure of a battery, and by allowing a safety vent of the battery to be easily opened by the gas produced by the additives.

Similarly, methods for enhancing battery safety are disclosed in U.S. Pat. Nos. 5,763,119, 5,709,968 and 5,858,573, in which an electrolyte includes additve such as 1,2-dimethoxy-4-bromo-benzene, 2-chloro-p-xyline and 4-chloro-anisol, and 2,7-diacetyl thianthrene, respectively.

Also, Japanese Patent Laid-Open Publication No. Hei 7-302614 discloses a battery protecting method in which overcharge current is consumed by forming a polymer using a terphenyl benzene compound.

However, such conventional additives may be polymerized even under normal operating conditions or may produce a large amount of gas due to oxidative decomposition, resulting in swelling of a battery. Also, use of such conventional additives may deteriorate various battery performance characteristics such as formation, standard capacity or cycle life.

### SUMMARY OF THE INVENTION

To solve the above-described problems, it is a first object of the present invention to provide a nonaqueous electrolyte that can improve battery safety by suppressing risks of rupture, ignition or explosion of a battery when the battery is overcharged due to some uncontrolled conditions. These conditions include failure of a charger or when the battery is exposed to high temperature, which can suppress swelling, and which can prevent deterioration in formation, standard capacity and cycle life characteristics of the battery.

It is a second object of the present invention to provide a lithium battery with improved overcharge safety.

To accomplish the first object, an embodiment of the present invention provides a nonaqueous electrolyte comprising an organic solvent, a lithium salt, and a compound represented by the formula 1:

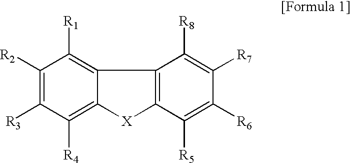

wherein R₁, R₂, R₃, R₄, R₅, R₆, R₇ and R₈ are the same or are different, and are independently hydrogen, hydroxyl, halogen, a C1-C10 alkyl, a C1-C10 alkoxy, nitro or amine group, and —X— is —O—, —NR₉— or —S—, and wherein R₉ is hydrogen, hydroxyl, halogen, a C1-C10 alkyl, a C1-C10 alkoxy, nitro or amine group.

In an embodiment of the present invention, the amount of the compound represented by the formula 1 is in the range of 1 to 20% by weight, based on the total amount of a mixed solution of the organic solvent and the lithium salt.

In another embodiment of the present invention, the compound represented by the formula 1 is preferably diphenylene oxide represented by the formula 2:

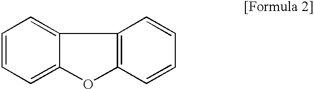

In accordance with another aspect of the present invention, there is provided a lithium secondary battery using the nonaqueous electrolyte.

### BRIEF DESCRIPTION OF THE DRAWINGS

The above objects and advantages of the present invention will become more apparent by describing in detail preferred embodiments thereof with reference to the attached drawings in which:

FIG. 1 is a graph showing the results of overcharge test for a lithium battery using an electrolyte prepared in Comparative Example 1 of the prior art;

FIG. 2 is a graph showing the results of overcharge test for a lithium battery using an electrolyte prepared in Example 1 of the present invention;

FIG. 3 shows cycle life characteristics of a lithium battery using electrolytes prepared in Example 2 of the present invention and Comparative Example 2; and

FIG. 4 shows oxidative decomposition potentials of a lithium battery using electrolytes prepared in Example 1 of the present invention.

### DETAILED DESCRIPTION OF THE INVENTION

The present invention will now be described in detail.

The present invention provides a nonaqueous electrolyte comprising a compound represented by the formula 1:

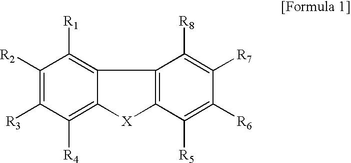

wherein R₁, R₂, R₃, R₄, R₅, R₆, R₇ and R₈ are the same or are different, and are independently hydrogen, hydroxyl, halogen, a C1-C10 alkyl, a C1-C10 alkoxy, nitro or amine group, and —X— is —O—, —NR₉— or —S—, and wherein R₉ is hydrogen, hydroxyl, halogen, a C1-C10 alkyl, a C1-C10 alkoxy, nitro or amine group.

Unlike conventional electrolyte additives, e.g., terphenyls, the compound represented by the formula 1 having high affinity for an organic solvent in the electrolyte has little affect on battery performance under normal use condition, that is, at 2.75-4.2 V, the additive is oxidized during overcharge of a battery to cause polymerization at the surface of a cathode so that a coating is formed on the cathode surface. Accordingly, cathode-anode resistance increases and the polymerizable coating having some ionic and conductive properties causes a soft short (shunting) effect between the cathode and the anode, consuming overcharge current, thereby protecting the battery.

Thus, use of the electrolyte comprising the compound represented by the formula 1, as well as a lithium salt dissolved in an organic solvent, reduces unfavorable side effects, e.g., polymerization, and it ensures overcharge safety of the battery while preventing deterioration of formation, standard capacity, swelling and cycle life characteristics.

The compound represented by the formula 1 is preferably used in an amount of 1 to 20% by weight, more preferably 3 to 15% by weight, based on the total weight of a nonaqueous electrolyte. If the amount is less than 1%, desired effects are difficult to achieve. If the amount is greater than 20%, cycle life characteristics undesirably deteriorate.

Any organic solvent useful for the electrolytes can be generally used for manufacture of lithium batteries without particular limitation, and examples thereof include at least one selected from the group consisting of ethylene carbonate, propylene carbonate, dimethyl carbonate, diethyl carbonate, dipropyl carbonate, ethylmethyl carbonate, dimethyl sulfoxide, acetonitrile, dimethoxyethane, tetrahydrofuran, acetone, dimethylformamide, cyclohexanone, fluorobenzene and N-methyl-2-pyrrolidone. The content of the organic solvent is in the range typically used for the manufacture of lithium batteries as is well known in the art.

Lithium salts useful for the electrolyte include, but are not limited to, any lithium compounds capable of being dissociated in an organic solvent to produce lithium ions, and examples thereof include at least one ionic lithium salt selected from the group consisting of lithium perchloric acid (LiClO₄), lithium tetrafluoroboric acid (LiBF₄), lithium hexafluorophosphoric acid (LiPF₆), lithium trifluoromethanesulfonic acid (LiCF₃SO₃) and lithium bis(trifluoromethanesulfonyl)amide (LiN(CF₃SO₂)₂). The content of the lithium salt is in the range typically used for the manufacture of lithium batteries as is well known in the art. The organic electrolyte containing an inorganic salt serves as a path for moving lithium ions in a direction of current flow.

The defined electrolyte can be used for any method of manufacturing lithium batteries without limitation. Exemplary manufacturing methods are as follows:

(1) An electrode assembly comprised of an anode/a cathode/a separator is put into a battery case and the electrolyte according to the present invention is inserted into the electrode assembly, thereby completing a lithium battery;

(2) A polymer electrolyte prepared by mixing a matrix-forming polymer resin and the electrolyte according to the present invention is applied to an electrode or a separator to form an electrode assembly, and the electrode assembly is put into a battery case, thereby completing a lithium battery; or

(3) A polymer electrolyte composition comprising a pre-polymer or polymerizable monomer as a matrix-forming resin and an electrolyte according to the present invention, is applied to an electrode or to a separator to form an electrode assembly, the electrode assembly is put into a battery case and then polymerization is carried out, thereby completing a lithium battery.

Any separator that can be generally used in manufacturing lithium batteries is used without any limitations, and examples thereof include a polyethylene or polypropylene porous layer less reactive with an organic solvent and suitable for attaining a safe battery.

Examples of the matrix forming polymer resin include, but are not limited to, any material useful for a binder of an electrode plate, and examples include a vinylidenefluoride/hexafluoropropylene copolymer, polyvinylidenefluoride, polyacrylonitrile, polymethylmethacrylate and mixtures thereof.

The polymer electrolyte may further include a polymer filler serving to enhance the mechanical strength of the polymer electrolyte, and examples of the filler include silica, kaolin and alumina.

The polymer electrolyte may further include a plasticizer, and examples of the plasticizer include ethylene glycol derivatives, oligomers thereof and organic carbonates. Examples of the ethylene glycol derivatives include ethylene glycol diacetate, ethylene glycol dibutylether, ethylene glycol dibutyrate, ethylene glycol dipropionate, propylene glycol methyletheracetate and mixture thereof. Examples of the organic carbonates include ethylene carbonate, propylene carbonate, diethyl carbonate, dimethyl carbonate, and mixtures thereof.

The lithium battery containing the electrolyte according to the present invention is not particularly limited in its type, and the present invention can be applied to primary batteries and secondary batteries or to lithium sulfur batteries.

The lithium battery containing the electrolyte according to the present invention is not particularly limited in its shape, and the present invention can be applied to both rectangular and cylindrical batteries without limitation.

To further illustrate the present invention in greater detail, the following examples will be given. However, it is to be understood that the present invention is not restricted thereto.

1. Preparation of Cathode

A mixture (slurry or paste) prepared by dissolving LiCoO₂ employed as a cathode active material, Super-P (manufactured by M.M.M. Corp.) employed as a conductive agent and polyvinylidenefluoride (PVDF) employed as a binder in N-methyl-2-pyrrolidone (NMP) employed as an organic solvent, was uniformly applied onto both surfaces of an aluminum current collector to prepare a cathode coated with an active material, followed by drying to remove the organic solvent and compression molding using a roll press machine, thereby manufacturing a cathode of 0.147 mm in thickness.

2. Manufacture of Anode

A mixture (slurry or paste) prepared by dissolving mesocarbon fiber (MCF) (manufactured by Petoca Ltd.) employed as an anode active material and PVDF employed as a binder in NMP employed as an organic solvent, was applied onto both surfaces of a copper current collector to prepare an anode coated with an active maerial, followed by drying to remove the organic solvent and compression molding using a roll press machine, thereby manufacturing an anode of 0.178 mm in thickness.

3. Preparation of Electrode Assembly

The manufactured cathode and anode were stacked with a polyethylene porous layer, which is less reactive with an organic solvent and is suitably thick, that is, 0.025 mm, disposed therebetween, thereby fabricating a rectangular battery having a capacity of approximately 900 mAh.

4. Preparation of Electrolyte

### EXAMPLE 1

LiPF₆ as a lithium salt was dissolved to a final concentration of 1.15M in a mixed solvent of ethylene carbonate (EC)/ethylmethyl carbonate (EMC)/propylene carbonate (PC)/fluorobenzene (FB) (volume ratio=30/55/5/10) to obtain a mixed solution. To the obtained mixed solution was added 3% by weight of diphenylene oxide represented by the formula 2 (manufactured by Nippon Steel Chemical co.), based on the total amount of the mixed solution, thereby obtaining a desired electrolyte represented by the formula 2:

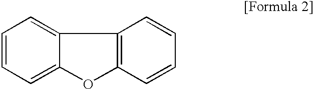

### EXAMPLE 2

LiPF₆ as a lithium salt was dissolved to a final concentration of 1.15M in a mixed solvent of EC/EMC/PC/FB (volume ratio=30/55/5/10) to obtain a mixed solution. To the obtained mixed solution was added 5% by weight of a hydride of diphenylene oxide represented by the formula 2 (manufactured by Nippon Steel Chemical Co.), based on the total amount of the mixed solution, thereby obtaining a desired electrolyte.

### EXAMPLE 3

LiPF₆ as a lithium salt was dissolved to a final concentration of 1.15M in a mixed solvent of EC/EMC/PC/FB (volume ratio=30/55/5/10) to obtain a mixed solution. To the obtained mixed solution was added 10% by weight of a hydride of diphenylene oxide represented by the formula 2 (manufactured by Nippon Steel Chemical Co.), based on the total amount of the mixed solution, thereby obtaining a desired electrolyte.

### COMPARATIVE EXAMPLE 1

LiPF₆ as a lithium salt was mixed to a final concentration of 1.15M in a mixed solvent of EC/EMC/PC/FB (volume ratio=30/55/5/10) to obtain a desired electrolyte.

### COMPARATIVE EXAMPLE 2

LiPF₆ as a lithium salt was mixed to a final concentration of 1.15M in a mixed solvent of EC/EMC/PC/FB (volume ratio=30/55/5/10) to obtain a mixed solution. To the mixed solution was added 5% by weight of o-terphenyl, thereby obtaining a desired electrolyte.

5. Preparation of Lithium Ion Battery.

A separator was disposed on upper and bottom surfaces of the prepared electrode assembly, and the resultant structure was wound and compressed, followed by putting the same into a 34 mm×50 mm×06 mm rectangular can. Each of the obtained electrolytes as discussed above was injected into the can, thereby preparing lithium ion batteries.

### TEST EXAMPLE 1

### Overcharge Test

The prepared lithium ion batteries were charged with a charging current of 950 mA (1 C) at room temperature to become a voltage of 4.2 V, and charged for 3 hours at a constant voltage of 4.2 V to reach a fully charged state. Overcharging was performed by applying a charging current of 950 mA (1 C) between a cathode and an anode of each fully charged battery for approximately 2.5 hours, and changes in charging voltage and temperature were observed.

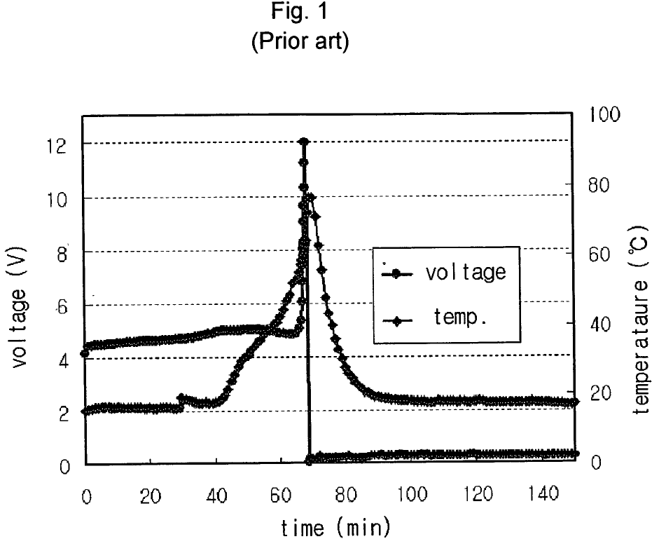

FIG. 1 shows overcharge test results on the lithium ion battery prepared in Comparative Example 1 with a charging current of 950 mA (1 C). As shown in FIG. 1, when an external voltage of 12 V was applied, separator shutdown may be resulted from exhaustion of electrolyte or a temperature rise due to the oxidation between a cathode/anode and an electrolyte. Also, when a high current of approximately 1 C is applied to the lithium ion battery, thermal runaway occurs to the battery to cause dissolution of a separator, resulting in internal short, heat or fire.

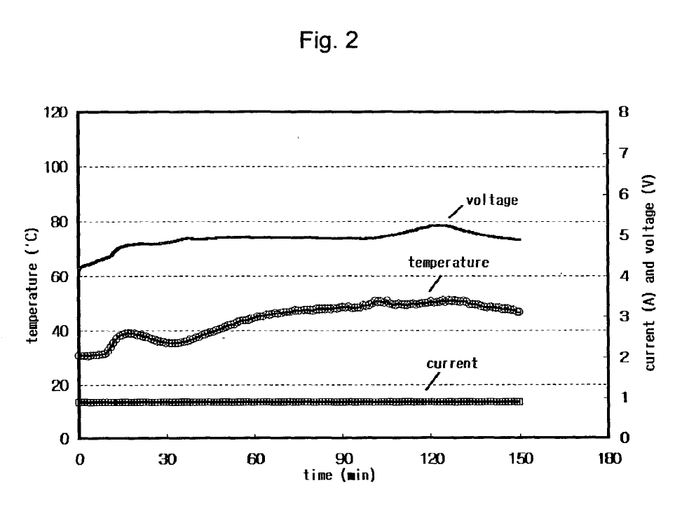

FIG. 2 shows the overcharge test result performed on the lithium ion battery prepared in Example 1 under the same conditions as in Comparative Example 1. As shown in the drawing, polymerization takes place due to an additive of the present invention approximately 10 minutes after the overcharge test, so that the temperature rises. However, since overcharging current is continuously consumed, a voltage rise is suppressed at approximately 5 V. Also, since heat generation due to oxidative decomposition of an electrolyte and battery materials is also suppressed, the temperature of a battery surface is controlled to be approximately 50□ or below. Since thermal runaway is fundamentally suppressed, battery safety can be ensured.

### TEST EXAMPLE 2

### Formation and Swelling Characteristics

Observation of formation capacity, standard capacity and swelling characteristics before and after formation were carried out on the batteries prepared in Examples 1-3 and in Comparative Examples 1 and 2 and the results thereof are listed in Table 1. The batteries were charged at 0.2 C to a voltage of 4.2 V and then were discharged at 0.2 C to an end voltage of 2.75 V. To determine swelling characteristics, thicknesses of the batteries were measured. The results are shown in Table 1.

TABLE 1

| | Swelling | | | | |
|---|---|---|---|---|---|
| | before | | | | |
| | and after | Formation capacity (mAh) | | | Standard |
| | formation | | | Efficiency | capacity |
| | (mm) | Charge | Discharge | (%) | (mAh) |
| Example 1 | 5.07 | 976 | 926 | 95 | 941 |
| Example 2 | 5.08 | 945 | 945 | 96 | 950 |
| Example 3 | 5.10 | 952 | 898 | 94 | 905 |
| Comparative | 5.09 | 958 | 883 | 92 | 934 |
| Example 1 | | | | | |
| Comparative | 5.74 | 939 | 865 | 92 | 851 |
| Example 2 | | | | | |

As shown in Table 1, the lithium battery prepared in Comparative Example 2 with a conventional overcharge preventing additive, is higher than that prepared in Comparative Example 1 without an overcharge preventing additive, in view of the degree of swelling, which occurs because a large amount of gas is produced due to oxidative decomposition of the overcharge preventing additive.

However, the lithium batteries prepared in Examples 1-3, in which overcharge preventing additives of the present invention are used, show substantially the same degree of swelling compared to the lithium battery prepared in Comparative Example 1. That is to say, the additives of the present invention are shown to suppress swelling.

The lithium batteries according to the present invention are also highly effective in view of formation and standard capacity characteristics.

### TEST EXAMPLE 3

### Cycle Life Characteristics

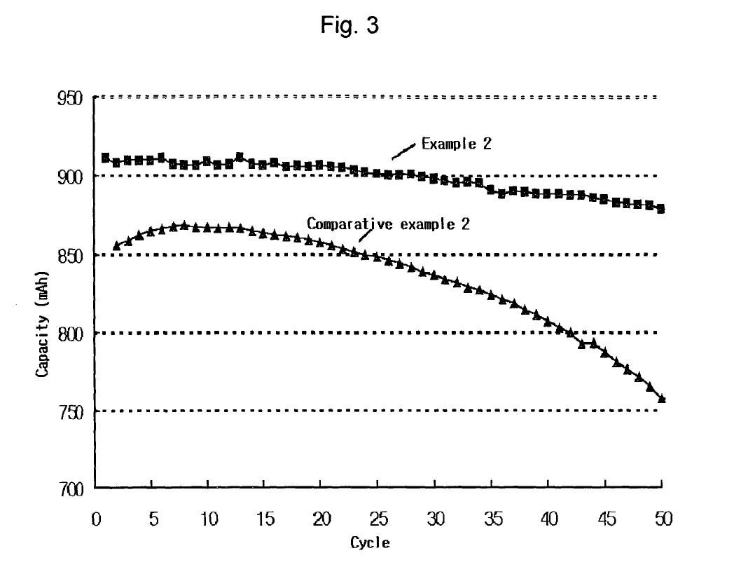

Charge/discharge cycle life characteristics were tested on the lithium batteries prepared in Example 2 and in Comparative Example 2. Charge/discharge cycling tests were carried out under the conditions of constant current and constant voltage at 1 C and to 2.7-4.2 V, respectively. The constant voltage period was 1/10 the constant current period. The capacity and charge/discharge cycle life characteristics of the batteries are shown in FIG. 3.

As shown in FIG. 3, the lithium battery using the overcharge preventing additive of Example 2 was proven to have much higher capacity after 50 cycles, that is, better cycle life characteristics than does the lithium battery using the conventional overcharge preventing additive.

### TEST EXAMPLE 4

### Measurement of Oxidative Decomposition Potential

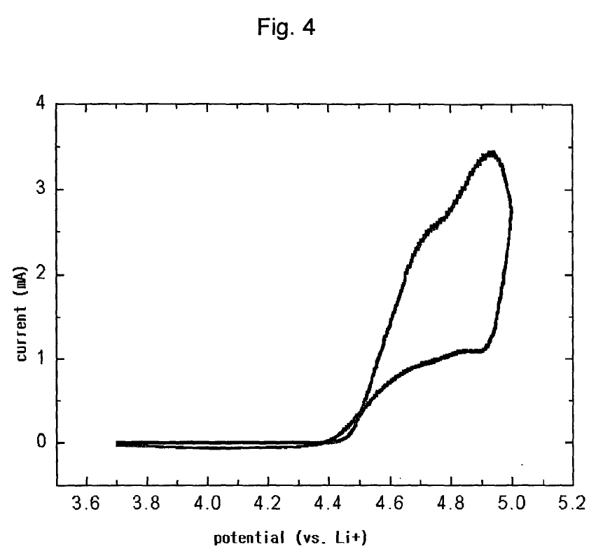

The oxidative decomposition potential of the lithium battery prepared in Example 1 was measured, and the result thereof is shown in FIG. 4. As shown in FIG. 4, the lithium batteries according to the present invention experienced little oxidative decomposition in a battery use area.

As described above, the nonaqueous electrolyte according to the present invention forms a polymer due to its oxidative decomposition even if there is an increase in voltage due to overcharge of a battery by some uncontrollable conditions, so that overcharge current is continuously consumed, thereby protecting the battery. Therefore, overcharge safety of the battery can be enhanced and occurrence of swelling is reduced. Also, deterioration in formation, standard capacity and cycle life characteristics can be prevented. Further, the nonaqueous electrolyte according to the present invention can be advantageously applied to lithium batteries and the like.

What is claimed is:

1. A nonaqueous electrolyte comprising:
an organic solvent;
a lithium salt; and
a compound represented by the formula 1: 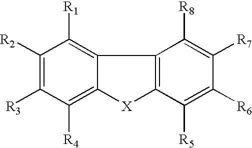
wherein R₁, R₂, R₃, R₄, R₅, R₆, R₇ and R₈ are the same or are different, and are independently hydrogen, hydroxyl, halogen, a C1-C10 alkyl, a C1-C10 alkoxy, nitro or amine group, and —X— is —O—, —NR₉— or —S—, and wherein R₉ is hydrogen, hydroxyl, halogen, a C1-C10 alkyl, a C1-C10 alkoxy, nitro or amine group.

2. The nonaqueous electrolyte according to claim 1, wherein the amount of the compound represented by the formula 1 is 1 to 20% by weight based on the total amount of a mixed solution of the organic solvent and the lithium salt.

3. The nonaqueous electrolyte according to claim 1, wherein the amount of the compound represented by the formula 1 is 3 to 15% by weight based on the total amount of a mixed solution of the organic solvent and the lithium salt.

4. The nonaqueous elecrolyte according to claim 1, wherein the compound represented by the formula 1 is represented by the formula 2:

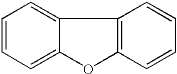

5. A lithium battery having an anode, a cathode, a separator, and a polymer electrolyte composition containing an electrolyte applied onto the electrodes and/or the separator, wherein the electrolyte comprises:
an organic solvent;
a lithium salt; and
a compound represented by the formula 1: 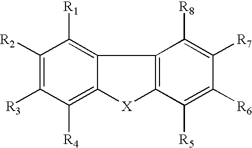
wherein R₁, R₂, R₃, R₄, R₅, R₆, R₇ and R₈ are the same or are different, and are independently hydrogen, hydroxyl, halogen, a C1-C10 alkyl, a C1-C10 alkoxy, nitro or amine group, and —X— is —O—, —NR₉— or —S—, and wherein R₉ is hydrogen, hydroxyl, halogen, a C1-C10 alkyl, a C1-C10 alkoxy, nitro or amine group.

6. The lithium battery according to claim 5, wherein the amount of the compound represented by the formula 1 is 1 to 20% by weight based on the total amount of a mixed solution of the organic solvent and the lithium salt.

7. The lithium battery according to claim 5, wherein the amount of the compound represented by the formula 1 is 3 to 15% by weight based on the total amount of a mixed solution of the organic solvent and the lithium salt.

8. The lithium battery according to claim 5, wherein the compound represented by the formula 1 is represented by the formula 2: [chemical structure]
